(19) United States
(12) Patent Application Publication
(10) Pub. No.: US 2009/0024395 A1
(43) Pub. Date: Jan. 22, 2009

(54) AUDIO SIGNAL ENCODING METHOD, AUDIO SIGNAL DECODING METHOD, TRANSMITTER, RECEIVER, AND WIRELESS MICROPHONE SYSTEM

(75) Inventor: Yutaka Banba, Kanagawa-ken (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 10/597,215

(22) PCT Filed: Jan. 18, 2005
(86) PCT No.: PCT/JP05/00510

§ 371 Date: Jul. 17, 2006

(30) Foreign Application Priority Data
Jan. 19, 2004 (JP) 2004-010040

(51) Int. Cl. G10L 19/00

(52) U.S. Cl. 704/500; 704/E19.001

(57) ABSTRACT

It is an object of the present invention to provide an audio signal encoding method, an audio signal decoding method, a transmitter, a receiver, and a wireless microphone system which can compress an audio signal at a relatively high compression ratio at a relatively high quality with a relatively low delay. The compression encoder 4 of the transmitter includes an audio signal dividing filter bank 4a for dividing the audio signal into four sub-band signals, sampling each of the sub-band signals at a down-sampling rate depending on the number of the sub-band signals, and producing the sub-band signals sampled at the down-sampling rate, LD-CELP encoders 20a to 20d for encoding the sub-band signals on the basis of LD-CELP algorithm, and a multiplexer 4c for producing a multiplexed data stream with the encoded sub-band signals.

### TECHNICAL FIELD OF THE INVENTION

The present invention relates to an audio signal encoding method of encoding an audio signal with a relatively low delay, an audio signal decoding method of decoding the audio signal encoded on the basis of the audio signal encoding method, a transmitter for encoding an audio signal on the basis of the audio signal encoding method, and transmitting the encoded audio signal, a receiver for receiving the encoded audio signal from the transmitter, and decoding the received audio signal to an original audio signal on the basis of the audio signal decoding method, and a wireless microphone system comprising the above-mentioned transmitter and receiver.

### DESCRIPTION OF THE RELATED ART

As a conventional encoding method of encoding an audio signal with a relatively low delay, and a conventional decoding method of decoding the encoded audio signal to an original audio signal, there have been known a sub-band adaptive differential pulse code modulation encoding method (hereinafter simply referred to as “sub-band ADPCM encoding method”), and a sub-band adaptive differential pulse code modulation decoding method (hereinafter simply referred to as “sub-band ADPCM decoding method”).

In a conventional wireless microphone system 200 comprising a transmitter including an encoder 204 for encoding an audio signal on the basis of the conventional sub-band ADPCM encoding method, and a receiver including a decoding unit 215 for decoding the encoded audio signal on the basis of the conventional sub-band ADPCM decoding method, the encoder 204 of the transmitter, as shown in FIG. 12, includes an audio signal dividing filter bank 204a for dividing an audio signal into four sub-band signals, and thinning the sub-band signals with a thinning rate depending on the division number, four ADPCM encoders 220a to 220d for encoding the thinned sub-band signals, a multiplexing unit 204c for multiplexing the encoded sub-band, and producing a data stream with the multiplexed sub-band signals.

On the other hand, the decoder 215 of the receiver includes a demultiplexer 215a for reproducing the encoded sub-band signals from the received data stream, four ADPCM decoders 230a to 230d for decoding the reproduced sub-band signals on the basis of the conventional sub-band ADPCM decoding method, an audio signal synthesizing filter bank 215c for interpolating the sub-band signals decoded by the ADPCM decoders 230a to 230d with an interpolating rate depending on the division number, and synthesizing an audio signal from the interpolated sub-band signals.

The operation of each of the encoder 204 of the transmitter and decoder 215 of the receiver will be then described hereinafter.

In the encoder 204 of the transmitter, the audio signal is firstly divided into four sub-band signals by the audio signal dividing filter bank 204a. The divided sub-band signals are then thinned at the thin rate depending on the division number by the audio signal dividing filter bank 204a. The thinned sub-band signals are then encoded by the ADPCM encoders 220a to 220d. The encoded sub-band signals are then multiplexed into a data stream by the multiplexer 204c.

On the other hand, the encoded sub-band signals is firstly reproduced from the data stream received from the transmitter by the demultiplexer 215a in the decoding unit 215 of the receiver. The encoded sub-band signals are then decoded by the ADPCM decoders 230a to 230d. The decoded sub-band signals are then interpolated with the interpolating rate depending on the division number. The audio signal is then synthesized from the interpolated sub-band signals by the audio signal synthesizing filter bank 215c(See patent document 1).

Patent document 1: Jpn. unexamined patent publication No. 2002-330075

### DISCLOSURE OF THE INVENTION

### Problems to be Solved by the Invention

The conventional audio signal encoding and decoding methods, however, encounter such a problem that, if the audio signal is compressed at one-fourth, one-fifth or more excessive compression ratio, the sound cannot be reproduced at a relatively high quality from the excessively compressed audio signal.

It is, therefore, an object of the present invention to provide an audio signal encoding method of encoding the audio signal at one-seventh, one-eight or so high compression ratio with a relatively low delay without deteriorating its sound quality, an audio signal decoding method of decoding the audio signal encoded on the basis of the audio signal encoding method with a relatively low delay, a transmitter for encoding the audio signal on the basis of the audio signal encoding method, and transmitting the encoded audio signal, a receiver for receiving the encoded audio signal from the transmitter, and reproduce an original audio signal from the received audio signal on the basis of the audio signal decoding method, and a wireless microphone system to be provided with the transmitter and the receiver.

### Means for Solving the Problems

In accordance with one aspect of the present invention, there is provided an audio signal encoding method, comprising: a producing step of dividing an audio signal into a plurality of sub-band signals, sampling the sub-band signals with respective down-sampling rates depending on the division number, and producing down-sampled sub-band signals; and an encoding step of producing vector indexes from the down-sampled sub-band signals by performing the vector quantization of the down-sampled sub-band signals on the basis of an analysis-by-synthesis method, the encoding step being of calculating a linear predictive coefficient from a previously decoded signal on the basis of a backward adaptive prediction method.

The audio signal encoding method thus constructed according to the present invention can encode the audio signal at a relatively high compression ratio without deteriorating its sound quality by reason that the encoding step is of performing the vector quantization of the sub-band signals on the basis of the backward adaptive prediction method, the quantization bit number to be unevenly allocated to each of the sub-band signals is determined on the basis of an energy distribution of each of the sub-band signals and a human's hearing characteristic.

In the audio signal encoding method, the encoding step is of producing an excitation vector by summing at least two vector code books.

The audio signal encoding method thus constructed according to the present invention can minimize the adverse impact of the compression of the audio signal on its sound quality, and keep both memory utilization and calculation amount as low as possible without deteriorating its sound quality.

In the audio signal encoding method, the encoding step is of producing a difference signal indicative of the difference between a predictive excitation gain and a real excitation gain, and performing the adaptive scalar quantization of the difference signal.

The audio signal encoding method thus constructed according to the present invention can adaptively and accurately quantize the difference between the predictive excitation gain and the real excitation gain.

In accordance with another aspect of the present invention, there is provided an audio signal decoding method of decoding an audio signal encoded on the basis of an audio signal encoding method which comprises a producing step of dividing an audio signal into a plurality of sub-band signals, sampling the sub-band signals with respective down-sampling rates depending on the division number, and producing down-sampled sub-band signals; and an encoding step of producing vector indexes from the down-sampled sub-band signals by performing the vector quantization of the down-sampled sub-band signals on the basis of an analysis-by-synthesis method, the encoding step being of calculating a linear predictive coefficient from a previously decoded signal on the basis of a backward adaptive prediction method, the audio signal decoding method comprising a decoding step of reproducing the down-sampled sub-band signals from the vector indexes by performing the inverse vector quantization of the vector indexes, and a synthesizing step of interpolating the reproduced sub-band signals with respective up-sampling rates, and reproducing the audio signal from the interpolated sub-band signals, the decoding step being of calculating a linear predictive coefficient from a previously decoded signal on the basis of the backward adaptive prediction method.

The audio signal decoding method thus constructed according to the present invention can reproduce the audio signal from the compressed signal at a relatively high quality with a relatively low delay on the basis of the backward adaptive prediction method.

In the audio signal decoding method, the decoding step is of receiving the vector indexes encoded on the basis of the audio signal encoding method in which the encoding step is of producing an excitation vector by summing at least two vector code books, the decoding step is of producing an excitation vector by summing at least two vectors equivalent to the vector indexes.

The audio signal decoding method thus constructed according to the present invention can reproduce the audio signal from the vector indexes.

In the audio signal decoding method, the decoding step is of receiving the vector indexes encoded on the basis of the audio signal encoding method in which the encoding step is of calculating, as a difference signal, the gain difference between a predictive excitation gain and a real excitation gain, and performing the adaptive scalar quantization of the difference signal, and the decoding step is of calculating, as an excitation gain, the addition between the predictive excitation gain and the gain difference obtained from the quantized difference signal on the basis of the backward adaptive prediction method.

The audio signal decoding method thus constructed according to the present invention can calculate an excitation gain with relatively high accuracy.

In accordance with further aspect of the present invention, there is provided a transmitter comprising an encoding unit for encoding an audio signal on the basis of an audio signal encoding method which comprises a producing step of dividing an audio signal into a plurality of sub-band signals, sampling the sub-band signals at respective down-sampling rates depending on the division number, and producing the sub-band signals sampled at the down-sampling rates, and an encoding step of producing vector indexes from the down-sampled sub-band signals by performing the vector quantization of the down-sampled sub-band signals on the basis of an analysis-by-synthesis method, the encoding step being of calculating a linear predictive coefficient from a previously decoded signal on the basis of a backward adaptive prediction method, the transmitter is adapted to transmit the audio signal encoded by the encoding unit, wherein the encoding unit includes an audio signal dividing filter bank for dividing the audio signal into a plurality of sub-band signals, sampling the sub-band signals at respective down-sampling rates depending on the number of the divided sub-band signals, and producing the sub-band signals sampled at the down-sampling rates, and an encoder for producing vector indexes from the down-sampled sub-band signals by performing the vector quantization of the down-sampled sub-band signals on the basis of an analysis-by-synthesis method, the encoder being adapted to calculate a linear predictive coefficient from a previously decoded signal on the basis of a backward adaptive prediction method.

The transmitter thus constructed according to the present invention can transmit the encoded and multiplexed sub-band signals to the receiver through a transmission channel having a relatively small transmission capacity.

In the transmitter according to the present invention, the encoder is adapted to produce an excitation vector by using the addition of at least two vector code books on the basis of the audio signal encoding method in which the encoding step is of producing an excitation vector by using the addition of at least two vector code books.

The transmitter thus constructed according to the present invention can transmit the encoded and multiplexed sub-band signals to the receiver through a transmission channel having a relatively small transmission capacity.

The transmitter as set forth in claim 7, in which the encoder is adapted to produce a difference signal indicative of the difference between a predictive excitation gain and a real excitation gain, and performing the adaptive scalar quantization of the difference signal on the basis of the audio signal encoding method in which the encoding step is of calculating, as a difference signal, the difference between a predictive excitation gain and a real excitation gain, and performing the adaptive scalar quantization of the difference signal.

The transmitter thus constructed according to the present invention can transmit the encoded and multiplexed sub-band signals to the receiver through a transmission channel having a relatively small transmission capacity.

In accordance with still further aspect of the present invention, there is provided a receiver comprising a decoding unit for receiving an audio signal encoded on the basis an audio signal encoding method which comprises a producing step of dividing the audio signal into a plurality of sub-band signals, sampling the sub-band signals at respective down-sampling rates depending on the number of the divided sub-band signals, and producing the sub-band signals sampled at the down-sampling rates, and an encoding step of producing vector indexes from the down-sampled sub-band signals by performing the vector quantization of the down-sampled sub-band signals on the basis of an analysis-by-synthesis method, the encoding step being of calculating a linear predictive coefficient from a previously decoded signal on the basis of a backward adaptive prediction method, the decoding unit being adapted to decode the received audio signal on the an audio signal decoding method which comprises a decoding step of reproducing the sub-band signals from the vector indexes by performing the inverse vector quantization of the vector indexes, and a synthesizing step of interpolating the reproduced sub-band signals at respective up-sampling rates, and reproducing an audio signal from the interpolated sub-band signals, the decoding step being of calculating a linear predictive coefficient from a previously decoded signal on the basis of the backward adaptive prediction method, wherein the decoding unit includes a decoder for reproducing the sub-band signals from the vector indexes by performing the inverse vector quantization of the vector indexes, and a sub-band synthesizing filter bank for interpolating the reproduced sub-band signals at respective up-sampling rates, and reproducing an audio signal from the interpolated sub-band signals, the decoder being adapted to calculate a linear predictive coefficient from a previously decoded signal on the basis of the backward adaptive prediction method.

The receiver thus constructed according to the present invention can receive the encoded audio signal from the transmitter through a transmission channel having a relatively small transmission capacity, and reproduce the audio signal from the encoded audio signal with a relatively low delay at a relatively high quality.

In the receiver according to the present invention, the decoder is adapted to produce an excitation vector by summing at least two vector code books on the basis of the audio signal encoding method in which the encoding step of the audio signal encoding method is of producing an excitation vector by using the addition of at least two vector code books, and the decoding step is of producing an excitation vector by using the addition of at least two vectors equivalent to the vector indexes.

The receiver thus constructed according to the present invention can receive the encoded audio signal from the transmitter through a transmission channel having a relatively small transmission capacity, and reproduce the audio signal from the encoded audio signal with a relatively low delay at a relatively high quality.

In the receiver according to the present invention, the decoder is adapted to calculate, as an excitation gain, the addition between the predictive excitation gain and the gain difference obtained from the quantized difference signal on the basis of the audio signal decoding method in which the encoding step of the audio signal encoding method is of calculating, as a difference signal, the gain difference between a predictive excitation gain and a real excitation gain, and performing the adaptive scalar quantization of the difference signal, and the decoding step is of calculating, as an excitation gain, the addition between the predictive excitation gain and the gain difference obtained from the quantized difference signal on the basis of the backward adaptive prediction method.

The receiver thus constructed according to the present invention can receive the encoded audio signal from the transmitter through a transmission channel having a relatively small transmission capacity, and reproduce the audio signal from the encoded audio signal with a relatively low delay at a relatively high quality.

In accordance with yet further aspect of the present invention, there is provided a wireless microphone system, comprising: a transmitter comprising an encoding unit for encoding an audio signal on the basis of an audio signal encoding method which comprises a producing step of dividing the audio signal into a plurality of sub-band signals, sampling the sub-band signals at respective down-sampling rates depending on the number of the divided sub-band signals, and producing the sub-band signals sampled at the down-sampling rates, and an encoding step of producing vector indexes from the down-sampled sub-band signals by performing the vector quantization of the down-sampled sub-band signals on the basis of an analysis-by-synthesis method, the encoding step being of calculating a linear predictive coefficient from a previously decoded signal on the basis of a backward adaptive prediction method, the transmitter being adapted to transmit the audio signal encoded by the encoding unit, wherein the encoding unit includes an audio signal dividing filter bank for dividing the audio signal into a plurality of sub-band signals, sampling the sub-band signals at respective down-sampling rates depending on the number of the divided sub-band signals, and producing the sub-band signals sampled at the down-sampling rates, and an encoder for producing vector indexes from the down-sampled sub-band signals by performing the vector quantization of the down-sampled sub-band signals on the basis of an analysis-by-synthesis method, the encoder being adapted to calculate a linear predictive coefficient from a previously decoded signal on the basis of a backward adaptive prediction method.

The wireless microphone system thus constructed according to the present invention can make an effective use of an assigned frequency range, and can be easily constituted as a multi-channel communication system by reason that the audio signal can be encoded at a relatively high compression ratio.

The wireless microphone system according to the present invention further comprises: a receiver comprising a decoding unit for receiving an audio signal encoded on the basis an audio signal encoding method which comprises a producing step of dividing the audio signal into a plurality of sub-band signals, sampling the sub-band signals at respective down-sampling rates depending on the number of the divided sub-band signals, and producing the sub-band signals sampled at the down-sampling rates, and an encoding step of producing vector indexes from the down-sampled sub-band signals by performing the vector quantization of the down-sampled sub-band signals on the basis of an analysis-by-synthesis method, the encoding step being of calculating a linear predictive coefficient from a previously decoded signal on the basis of a backward adaptive prediction method, the decoding unit being adapted to decode the received audio signal on the an audio signal decoding method which comprises a decoding step of reproducing the sub-band signals from the vector indexes by performing the inverse vector quantization of the vector indexes, and a synthesizing step of interpolating the reproduced sub-band signals at respective up-sampling rates, and reproducing an audio signal from the interpolated sub-band signals, the decoding step being of calculating a linear predictive coefficient from a previously decoded signal on the basis of the backward adaptive prediction method, wherein the decoding unit includes a decoder for reproducing the sub-band signals from the vector indexes by performing the inverse vector quantization of the vector indexes, and a sub-band synthesizing filter bank for interpolating the reproduced sub-band signals at respective up-sampling rates, and reproducing an audio signal from the interpolated sub-band signals, the decoder being adapted to calculate a linear predictive coefficient from a previously decoded signal on the basis of the backward adaptive prediction method.

The wireless microphone system thus constructed according to the present invention can make an effective use of an assigned frequency range, and can be easily constituted as a multi-channel communication system by reason that the audio signal can be reproduced at a relatively high quality from the audio signal encoded at a relatively high compression ratio.

### ADVANTAGEOUS EFFECT OF THE INVENTION

Each of the audio signal encoding method, the audio signal decoding method, the transmitter, the receiver, and the wireless microphone system according to the present invention can obtain an effect to reproduce the audio signal from at a relatively high quality,

### BRIEF DESCRIPTION OF THE DRAWINGS

FIG. 1 is a block diagram showing the wireless microphone system according to the first to third embodiments of the present invention.

FIG. 2 is a block diagram showing the transmitter of the wireless microphone system according to the first to third embodiments of the present invention.

FIG. 3 is a block diagram showing the receiver of the wireless microphone system according to the first to third embodiments of the present invention.

FIG. 4 is a block diagram showing the encoder of the transmitter of the wireless microphone system according to the first to third embodiments of the present invention.

FIG. 5 is a block diagram showing the decoding unit of the receiver of the wireless microphone system according to the first to third embodiments of the present invention.

FIG. 6 is a block diagram showing each of the sub-band encoders of the encoder of the transmitter of the wireless microphone system according to the first embodiment of the present invention.

FIG. 7 is a block diagram showing each of the sub-band decoders of the decoding unit of the receiver of the wireless microphone system according to the first embodiment of the present invention.

FIG. 8 is a block diagram showing each of the sub-band encoders of the encoder of the transmitter of the wireless microphone system according to the second embodiment of the present invention.

FIG. 9 is a block diagram showing each of the sub-band decoders of the decoding unit of the receiver of the wireless microphone system according to the second embodiment of the present invention.

FIG. 10 is a block diagram showing each of the sub-band encoders of the encoder of the transmitter of the wireless microphone system according to the third embodiment of the present invention.

FIG. 11 is a block diagram showing each of the sub-band decoders of the decoding unit of the receiver of the wireless microphone system according to the third embodiment of the present invention.

FIG. 12 is a block diagram showing the conventional sub-band ADPCM encoding apparatus.

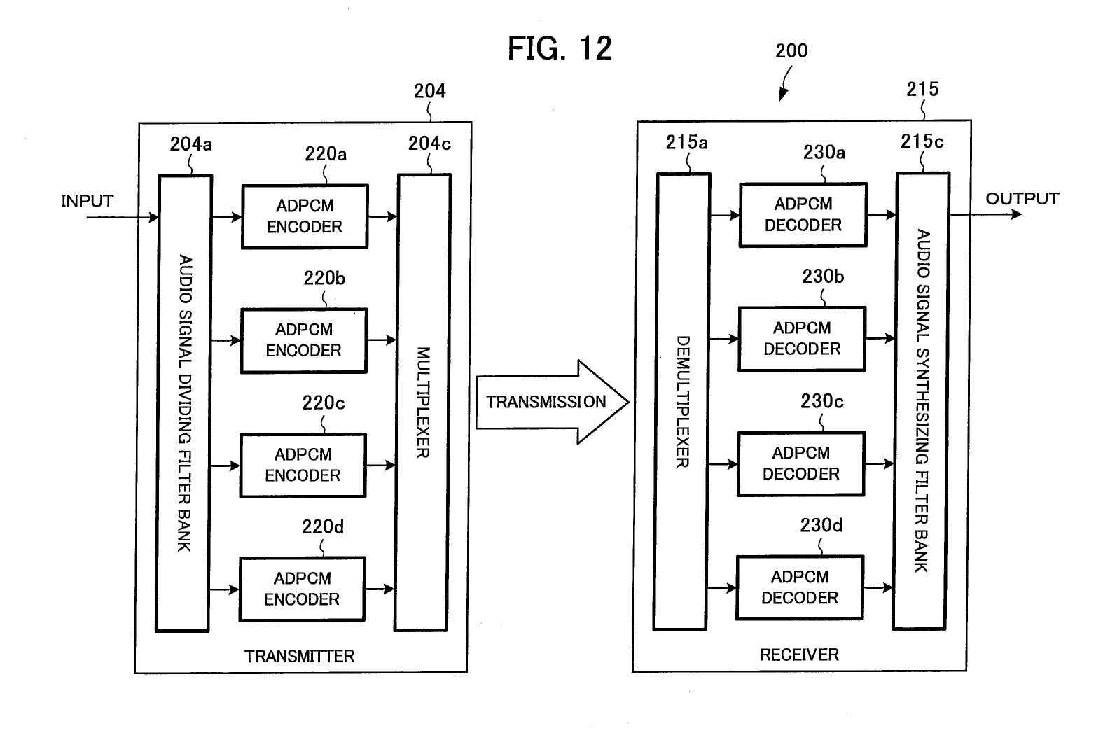

### EXPLANATION OF THE REFERENCE NUMERALS

100 wireless microphone system
101 transmitter
102 receiver
1 microphone unit
2 audio signal amplifier
3 analog-to-digital converter
4 compression encoder
5 error correction encoder
6 line encoder
7 high frequency signal amplifier
8 transmitting antenna
9 receiving antenna
10 high frequency signal amplifier
11 intermediate frequency signal amplifier
12 demodulator
13 line code decoder
14 code error corrector
15 compressed signal decoder
16 digital effecter
17 digital-to-analog converter
18 audio signal amplifier
19 speaker unit
4a audio signal dividing filter bank
4b vector encoder
4c multiplexer
15a demultiplexer
15b vector decoder
15c audio signal synthesizing filter bank
20a, 20b, 20c, 20d LD-CELP encoder
40a, 40b, 40c, 40d LD-CELP encoder
70a, 70b, 70c, 70d LD-CELP encoder
30a, 30b, 30c, 30d LD-CELP decoder
60a, 60b, 60c, 60d LD-CELP decoder
90a, 90b, 90c, 90d LD-CELP decoder
21 vector buffer
22 excitation VQ code book
23 gain multiplier
24 backward gain adjuster
25 synthesizing filter
26 backward coefficient adjuster
27 weighting filter
28 least mean square error calculator
29 adder
31 excitation VQ code book
32 gain multiplier
33 backward gain adjuster
34 synthesizing filter
35 backward coefficient adjuster
41 vector buffer
42 excitation VQ code book A 43 excitation VQ code book B
44 pre-selector
45 pre-selected code book A 46 pre-selected code book B
47 gain multiplier
48 backward gain adjuster
49 synthesizing filter
50 backward coefficient adjuster
51 weighting filter
52 least mean square error calculator
53 adder
54 adder
61 excitation VQ code book A
62 excitation VQ code book B
63 gain multiplier
64 backward gain adjuster
65 synthesizing filter
66 backward coefficient adjuster
67 adder
71 vector buffer
72 excitation VQ code book A
73 excitation VQ code book B
74 pre-selector
75 pre-selected code book A
76 pre-selected code book B
77 adaptive gain adder
78 gain multiplier
79 backward gain adjuster
80 synthesizing filter
81 backward coefficient adjuster
82 weighting filter
83 least mean square error calculator
84 adder
85 adder
91 excitation VQ code book A
92 excitation VQ code book B
93 adaptive gain adder
94 gain multiplier
95 backward gain adjuster
96 synthesizing filter
97 backward coefficient adjuster
98 adder

### DESCRIPTION OF THE PREFERRED EMBODIMENTS

### First Embodiment

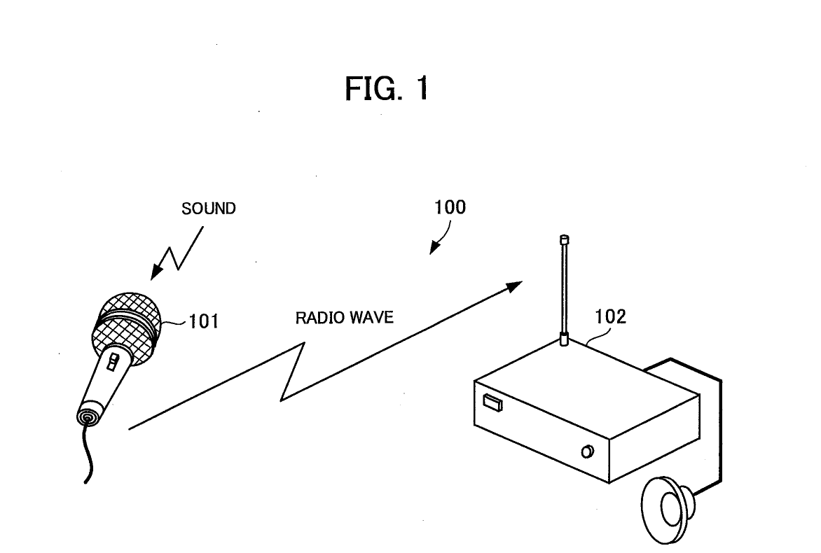

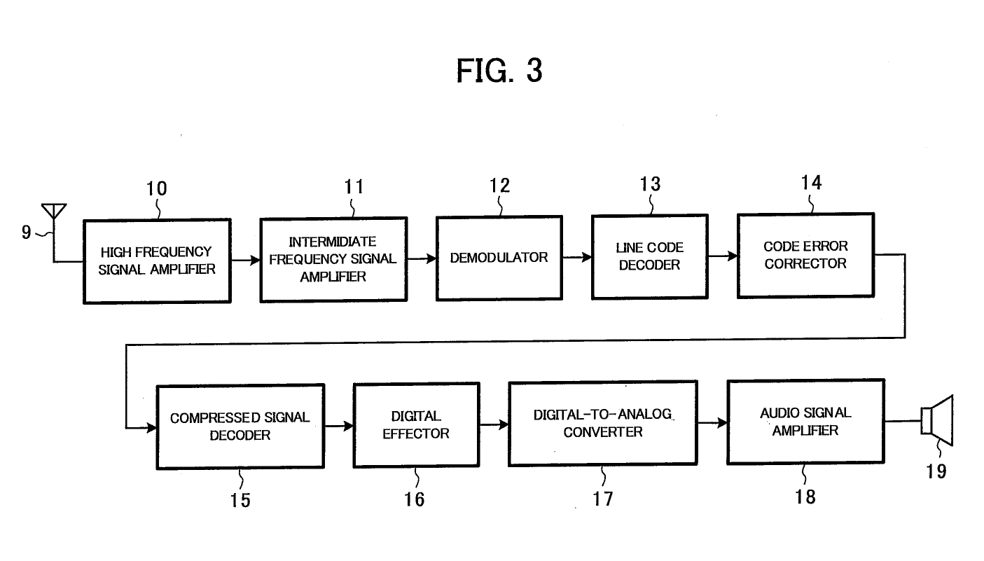

The first embodiment of the transmitter, the receiver, and the wireless microphone system according to the present invention will be described hereinafter with reference to FIGS. 1 to 6 of the accompanying drawings.

As shown in FIG. 1, the wireless microphone system 100 comprises a transmitter 101 for encoding an audio signal, and transmitting the encoded audio signal, and a receiver 102 for receiving the encoded audio signal from the transmitter 101.

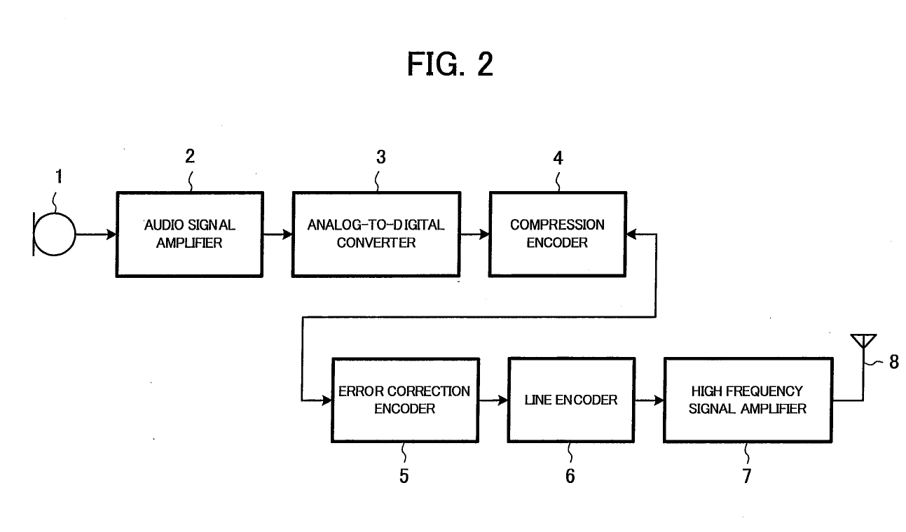

As shown in FIGS. 1 and 2, the transmitter 101 includes a microphone unit 1 for converting one's voice to an analog audio signal, an audio signal amplifier 2 for amplifying the analog audio signal converted by the microphone unit 1, an analog-to-digital converter 3 for sampling the analog audio signal amplified by the audio signal amplifier 2 at a predetermined sampling rate, and converting the sampled analog audio signal to a digital audio signal to be outputted at a predetermined bit rate, a compression encoder 4 for encoding the digital audio signal converted by the analog-to-digital converter 3 to ensure that the digital audio signal converted by the analog-to-digital converter 3 is compressed to data stream to be outputted at a relatively low bit rate, an error correction encoder 5 for encoding the data stream encoded by the compression encoder 4 to data stream having a relatively high tolerance to transmission errors, a line encoder 6 for producing a frame-structured transmission signal from the data stream encoded by the error correction encoder 5, the frame-structured transmission signal having additional information needed by the receiver 102, a high frequency signal amplifier 7 for digitally modulating and amplifying the frame-structured transmission signal produced by the line encoder 6 to ensure that the amplified transmission signal has a predetermined level, a transmitting antenna 8 for wirelessly outputting the transmission signal amplified by the high frequency signal amplifier 7 to the receiver 102.

The transmitter 101 further includes a setting unit (not shown) for setting parameters such as for example a bit rate of the analog-to-digital converter 3, a bit rate of the compression encoder 4, and a transmitting channel of the high frequency signal amplifier 7, and a controlling unit (not shown) for controlling the elements of the transmitter 101 on the basis of the parameters set by the setting unit (not shown).

The error correction encoder 5 is adapted to convert the data stream encoded by the compression encoder 4 to data stream having a relatively high tolerance to transmission errors by using a block code method, a convolution method, or an interleaving method.

On the other hand, the receiver 102, as shown in FIGS. 1 to 3, includes an receiving antenna 9 for receiving, as an input signal, the radio wave from the transmitter 101, a high frequency signal amplifier 10 for amplifying the received input signal, and producing an intermediate frequency signal from the amplified input signal by performing the frequency conversion of the amplified input signal, an intermediate frequency signal amplifier 11 for amplifying the intermediate frequency signal produced by the high frequency signal amplifier 10, and producing a band-limited intermediate frequency signal from the amplified intermediate frequency signal, a demodulator 12 for reproducing the frame-structured transmission signal from the band-limited intermediate frequency signal produced by the intermediate frequency signal amplifier 11, a line code decoder 13 for reproducing the data stream from the frame structured transmission signal reproduced by the demodulator 12 by detecting the additional information of the frame-structured transmission signal reproduced by the demodulator 12, a code error corrector 14 for performing the error correction of the data stream reproduced by the line code decoder 13, a compressed signal decoder 15 for reproducing the digital audio signal from the data stream corrected by the code error corrector 14, a digital effecter 16 for making appropriate sound effects with the digital audio signal reproduced by the compressed signal decoder 15, a digital-to-analog converter 17 for converting the digital audio signal to an analog audio signal, an audio signal amplifier 18 for amplifying the analog audio signal converted by the digital-to-analog converter 17, a speaker unit 19 for converting the audio signal amplified by the audio signal amplifier 18 to a sound, and loudening the converted sound.

The receiver 102 includes a setting unit (not shown) for inputting parameters such as for example a receiving channel of the high frequency signal amplifier 10 and a bit rate of the compressed signal decoder 15, and a controlling unit (not shown) for controlling the elements of the receiver 102 on the basis of the parameters inputted by the setting unit (not shown).

The digital effecter 16 is adapted to process the digital audio signal decoded by the compressed signal decoder 15 to make appropriate sound effects such as for example a howling suppression, an equalization, and a reverberation.

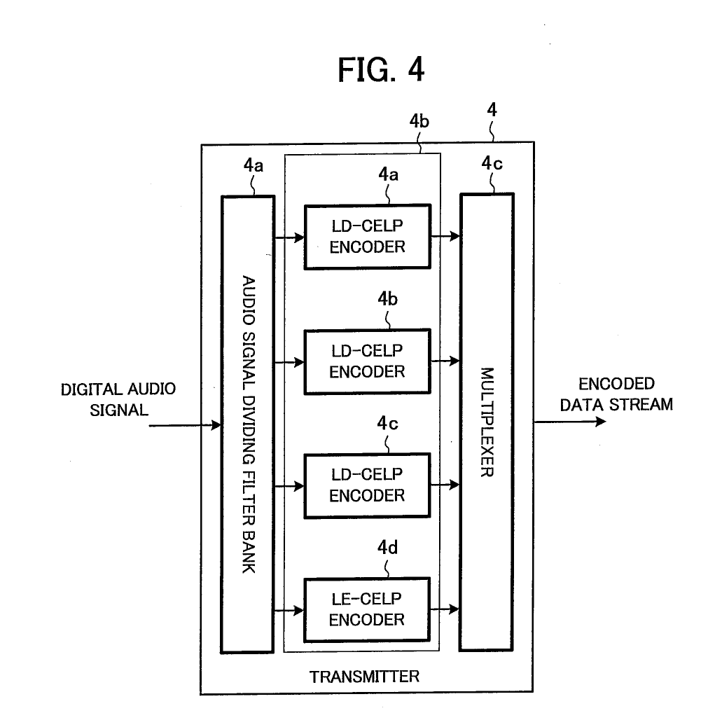

As shown in FIG. 4, the compression encoder 4 of the transmitter 101 includes an audio signal dividing filter bank 4a for dividing the audio signal into four sub-band signals, sampling each of the sub-band signals at a down-sampling rate depending on the number of the sub-band signals, and producing the sub-band signals sampled at the down-sampling rate, the audio signal having 8 [MHz] or more wide frequency range, a vector encoder 4b for producing vector indexes from the sub-band signals on the basis of the Low delay—Code Exited Linear Prediction (hereinafter simply referred to as “LD-CELP”) algorithm by performing the vector quantization of the sub-band signals on the basis of the analysis-by-synthesis method, and a multiplexer 4c for producing multiplexed data stream with the vector indexes produced by the vector encoder 4b.

The vector encoder 4b includes four LD-CELP encoders 20a to 20d for performing the vector quantization of the respective sub-band signals. The LD-CELP encoders 20a to 20d are adapted to produce linear prediction coefficients from the previously decoded signals on the basis of the backward adaptive prediction method.

Here, the term “LD-CELP algorithm” is intended to indicate an algorithm adopted as an international standard “T recommendation G.728” for 16 kbit/s speech communication by ITU (International Telecommunication Union).

The term “down-sampling” is intended to indicate that the audio signal sampled at a sampling rate is additionally sampled at a thinning-out rate lower than the sampling rate. On the other hand, the term “up-sampling” is intended to indicate that the audio signal sampled at a sampling rate is additionally sampled at an up-sampling rate higher than the sampling rate.

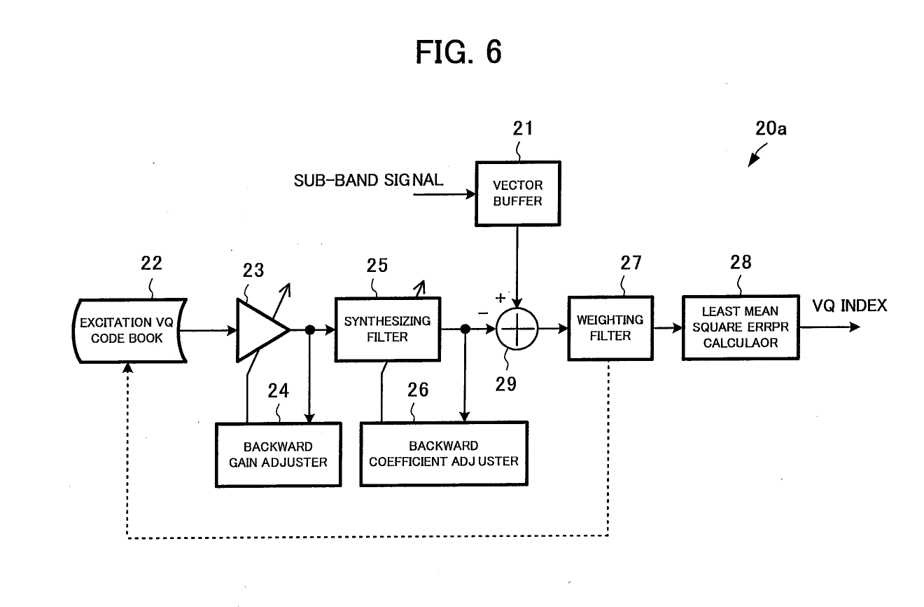

As shown in FIG. 6, the LD-CELP encoder 20a includes a vector buffer 21 for buffering the sub-band signals by the number of the dimension of the quantization vector, a backward gain adjuster 24 for linearly estimating a gain from the excitation vector adjusted in gain in response to a noise vector, a gain multiplier 23 for multiplying a signal by the gain linearly estimated by the backward gain adjuster 24, a synthesizing filter 25 for producing a decoded audio signal from the signal multiplied by the gain multiplier 23, a backward coefficient adjuster 26 for linearly estimating filter coefficients to be outputted to the synthesizing filter 25, and adaptively adjusting the filter coefficient of the synthesizing filter 25, an adder 29 for producing a difference signal indicative of the difference between the sub-band signals buffered by the vector buffer 21 and the signal produced by the synthesizing filter 25 by subtracting the signal produced by the synthesizing filter 25 from the sub-band signals buffered by the vector buffer 21, a weighting filter 27 for acoustically processing and producing a weighted difference signal from the difference signal produced by the adder 29, a least mean square error calculator 28 for calculating the least mean square error of the weighted difference signal produced by the weighting filter 27 to minimize the energy level of the weighted difference signal, and to obtain an index number from the excitation VQ code book 22.

Each of the LD-CELP encoders 20b, 20c, and 20d is the same in construction as the LD-CELP encoder 20a. The LD-CELP encoders 20b, 20c, and 20d are adapted to encode the sub-band signals to produce vector indexes from the sub-band signals.

The LD-CELP encoders 20a to 20d are adapted to output the vector indexes to the multiplexer 4c, while the multiplexer 4c is adapted to receive the vector indexes from the LD-CELP encoders 20a to 20d, and to produce data stream with the received vector indexes.

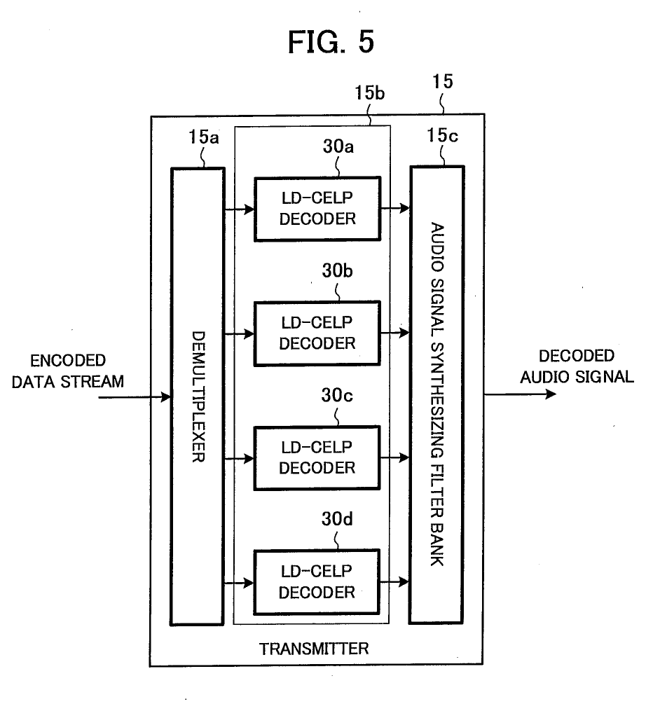

On the other hand, the compressed signal decoder 15 of the receiver 102, as shown in FIG. 5, includes a demultiplexer 15a for reproducing the vector indexes from the multiplexed data stream, a vector decoder 15b for reproducing the sub-band signals from the reproduced vector indexes, an audio signal synthesizing filter bank 15c for reproducing the audio signal from the reproduced sub-band signals by synthesizing the reproduced sub-band signals. The vector decoder 15b includes four LD-CELP decoders 30a to 30d for reproducing the respective sub-band signals from the vector indexes.

Each of the LD-CELP decoders 30a to 30d includes an excitation VQ code book 31, a gain multiplier 32, a backward gain adjuster 33, a synthesizing filter 34, and a backward coefficient adjuster 35. The LD-CELP decoders 30a to 30d are adapted to reproduce the sub-band signals from the vector indexes.

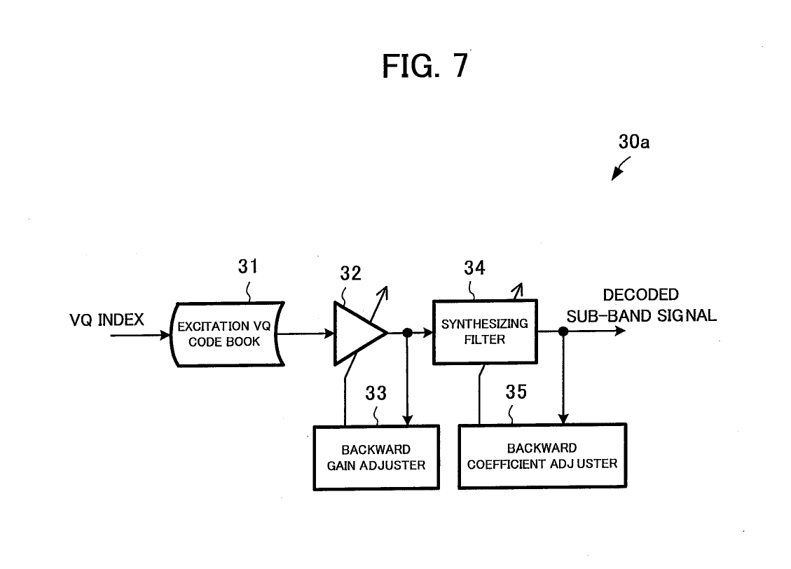

The operation of the compression encoder 4 of the transmitter 101 of the wireless microphone system 100 constructed as previously mentioned, and the operation of the compressed signal decoder 15 of the receiver 102 of the wireless microphone system 100 constructed as previously mentioned will be then described hereinafter with reference to FIGS. 6 and 7.

In the compression encoder 4 of the transmitter 101, the sub-band signals are buffered in the vector buffer 21, the number of each of the sub-band signals to be buffered in the vector buffer 21 being equal to the dimension of the vector space in which the quantization vector is defined. The gain multiplier 23 multiplies the excitation vector by a gain which is linearly predicted by the backward gain adjuster 24, while the sub-band audio signal is produced from the excitation vector adjusted in gain by the synthesizing filter 25. Here, the filter coefficients of the synthesizing filter 25 is adaptively adjusted by the backward coefficient adjuster 26 on the basis of the linear prediction of the sub-band signals previously reproduced by the synthesizing filter 25. The difference between the sub-band signal reproduced by the synthesizing filter 25 and the sub-band signal buffered in the vector buffer 21 (the difference signal) is calculated, and then weighted by the weighting filter 27. The least mean square error calculator 28 calculates an index number related to the excitation VQ vector by minimizing the energy of the difference signal, while the index numbers calculated by the LD-CELP encoders 20a to 20d are multiplexed to a data stream to be transmitted to the receiver 102 by the multiplexer 4c.

In the compressed signal decoder 15 of the receiver 102, the vector indexes are firstly reproduced from the multiplexed data stream by the demultiplexer 15a. The sub-band signals are then reproduced from the reproduced vector indexes by the LD-CELP decoder 30a to 30d, respectively. The sub-band signals interpolated at an up-sampling rate depending on the number of the divided sub-band signals are then produced from the reproduced sub-band signals. The audio signal is then reproduced from the interpolated sub-band signals.

From the foregoing description, it will be understood that the audio signal encoding method, the audio signal decoding method, the transmitter, the receiver, the wireless microphone system according to the first embodiment of the present invention can encode the audio signal, and reproduce the audio signal from the encoded audio signal at a relatively high quality with a relatively low delay by dividing the audio signal into a plurality of sub-band signals, and performing the vector quantization of the sub-band signals with no redundancy on the basis of the backward adaptive prediction method.

### Second Embodiment

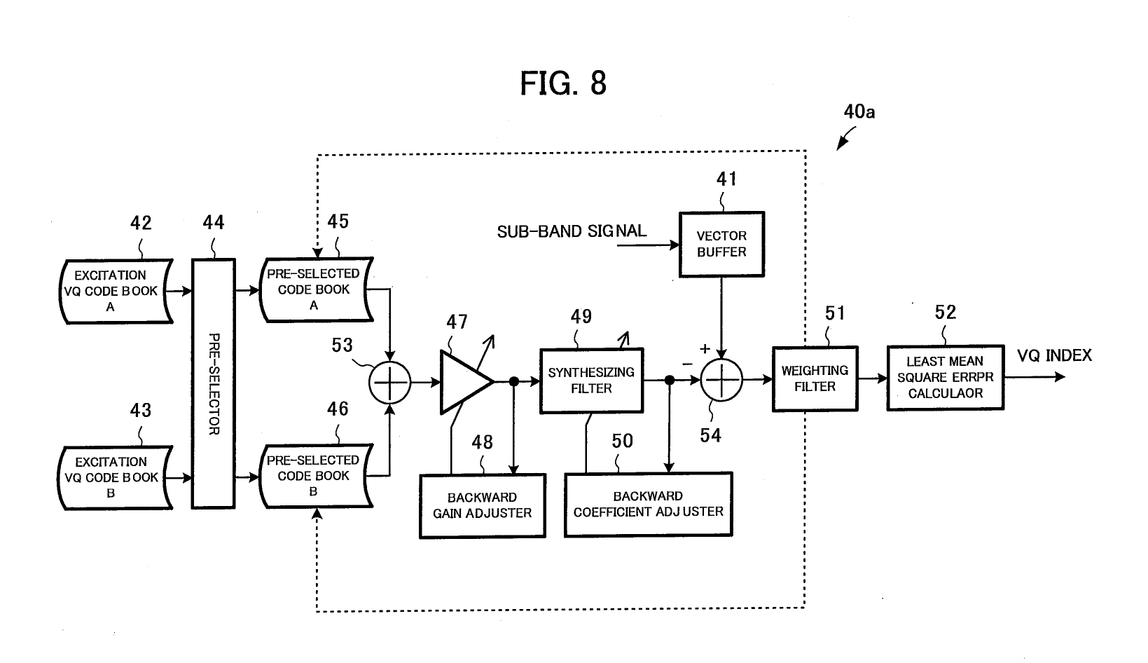

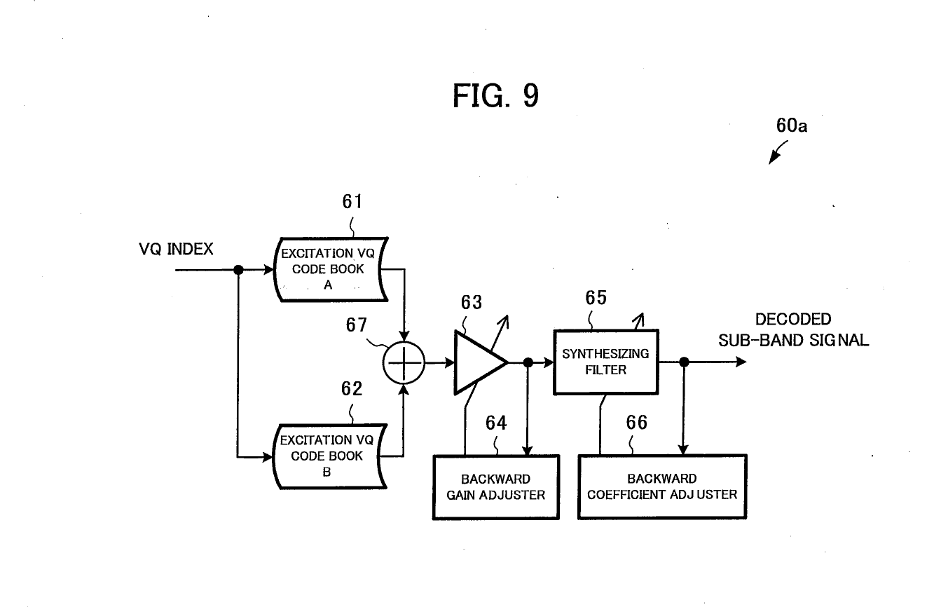

The transmitter, the receiver, and the wireless microphone system according to the second embodiment of the present invention will be described hereinafter with reference to FIGS. 8 and 9.

The wireless microphone system according to the second embodiment is similar in construction to the wireless microphone system according to the first embodiment. The wireless microphone system according to the second embodiment comprises a transmitter and a receiver.

The transmitter of the wireless microphone system according to the second embodiment is similar in construction to the transmitter of the wireless microphone system according to the first embodiment. The transmitter of the wireless microphone system according to the second embodiment includes a microphone unit 1, an audio signal amplifier 2, an analog-to-digital converter 3, a compression encoder 4, an error correction encoder 5, a line encoder 6, a high frequency signal amplifier 7, a transmitting antenna 8.

The compression encoder 4 of the transmitter includes an audio signal dividing filter bank 4a for dividing an audio signal into four sub-band signals, sampling each of the sub-band signals at a down-sampling rate depending on the number of the sub-band signals, the audio signal having 8 [MHz] or more wide frequency range, a vector encoder 4b for producing vector indexes from the sub-band signals on the basis of the Low delay—Code Exited Linear Prediction (hereinafter simply referred to as “LD-CELP”) algorithm by performing the vector quantization of the sub-band signals on the basis of an analysis-by-synthesis method, and a multiplexer 4c for producing a multiplexed data stream with the vector indexes produced by the vector encoder 4b. The vector encoder 4b includes four LD-CELP encoders 40a to 40d for performing the vector quantization of the respective sub-band signals.

As shown in FIG. 8, each of the LD-CELP encoders 40a to 40d includes a vector buffer 41, an excitation VQ code book A 42, an excitation VQ code book B 43, a pre-selector 44, a pre-selected code book A 45, a pre-selected code book B 46, an adder 53, a gain multiplier 47, a backward gain adjuster 48, a synthesizing filter 49, a backward coefficient adjuster 50, an adder 54, a weighting filter 51, and a least mean square error calculator 52.

On the other hand, the receiver 102 of the wireless microphone system 100 according to the second embodiment is similar in construction to the receiver 102 of the wireless microphone system 100 according to the first embodiment. The receiver 102 of the wireless microphone system 100 according to the second embodiment includes a receiving antenna 9, a high frequency signal amplifier 10, an intermediate frequency signal amplifier 11, a demodulator 12, a line code decoder 13, a code error corrector 14, a compressed signal decoder 15, a digital effecter 16, a digital-to-analog converter 17, an audio signal amplifier 18, and a speaker unit 19.

The receiver 102 includes a setting unit (not shown) for inputting parameters such as for example a receiving channel of the high frequency signal amplifier 10 and a bit rate of the compressed signal decoder 15, and a controlling unit (not shown) for controlling the elements of the receiver 102 on the basis of the parameters inputted by the setting unit (not shown).

On the other hand, the compressed signal decoder 15 of the receiver 102 includes a demultiplexer 15a for reproducing the vector indexes from the multiplexed data stream, a vector decoder 15b for reproducing the sub-band signals from the reproduced vector indexes, an audio signal synthesizing filter bank 15c for synthesizing an audio signal from the sub-band signals reproduced by the vector decoder 15b. The vector decoder 15b includes four LD-CELP decoders 60a to 60d for reproducing the respective sub-band signals from the vector indexes.

As shown in FIG. 9, each of the LD-CELP decoders 60a to 60d includes an excitation VQ code book A 61, an excitation VQ code book B 62, a gain multiplier 63, a backward gain adjuster 64, a synthesizing filter 65, a backward coefficient adjuster 66, and an adder 67.

The operation of the compression encoder 4 of the transmitter 101, and the operation of the compressed signal decoder 15 of the receiver 102 of the wireless microphone system 100 thus constructed will be then described hereinafter with reference to FIGS. 8 and 9.

In the compression encoder 4 of the transmitter 101, the audio signal is firstly divided into four sub-band signals by the audio signal dividing filter bank 4a, the divided sub-band signals having respective frequency ranges. Each of the sub-band signals are then sampled at a respective down-sampling proportional to the number of the divided sub-band signals. The down-sampled sub-band signals are then buffered in the vector buffer 41 by the dimension of the quantization vector. The pre-selector 44 is then operated to select two vectors approximately similar to the audio signal from the excitation VQ code book A 42 and the excitation VQ code book B 43. The selected vectors are then stored in the pre-selected code book A 45 and the pre-selected code book B 46. It is preferable to preliminarily select vectors the on the basis of a quasi-optimal method which is lower in the number of calculations than an analysis-by-synthesis method, and in which the combination of the vectors is selected through the steps of processing each of a target vector (produced from the previously inputted audio signal) and an excitation VQ vector (indicative of the vectorial sum of the vectors obtained from the excitation VQ code book A 42 and the excitation VQ code book B 43) by the synthesizing filter 49 and the weighting filter 51, calculating the cross-correlation between the sum of the target vector and the excitation VQ vector, and maximizing the cross-correlation multiplied by a backward gain. The vectorial sum of the vectors thus selected from the pre-selected code book A 45 and the pre-selected code book B 46 on the basis of the above-mentioned method is then calculated as an exaction vector. The optimum index number related to the optimum excitation vector is then selected by the least mean square error calculator 52 on the basis of the analysis-by-synthesis method. Here, the analysis-by-synthesis method is the same as that used in the first embodiment. The excitation vector is produced from the vectorial sum of the vectors of the pre-selected code book A 45 and the pre-selected code book B 46 on the basis of the analysis-by-synthesis method, while the gain multiplier 47 multiplies the excitation vector by the backward gain which is adaptively predicted by the backward gain adjuster 48. The sub-band audio signal is produced from the excitation vector multiplied by the backward gain by the synthesizing filter 49, while the filter coefficients of the synthesizing filter 49 is adaptively updated by the backward coefficient adjuster 50.

In the compressed signal decoder 15 of the receiver 102, the least mean square error calculator 52 is firstly operated to preliminarily select two vectors from the excitation VQ code book A 61 and the excitation VQ code book B 62 on the basis of the received VQ index, and to produce an excitation vector from the pre-selected vectors. Here, the excitation VQ code book A 61 and the excitation VQ code book B 62 of the compressed signal decoder 15 of the receiver 102 are the same as those of the compression encoder 4 of the transmitter 101. The produced excitation vector is then amplified by the gain multiplier 63, its gain being adaptively adjusted by the backward gain adjuster 64. The sub-bands signals are then reproduced from the amplified excitation vector by the synthesizing filter 65, its filter coefficients being adaptively adjusted by the backward coefficient adjuster 66. The audio signal are then synthesized from the reproduced sub-band signals by the audio signal synthesizing filter bank 15c.

From the foregoing description, it will be understood that the transmitter, the receiver, and the wireless microphone system according to the second embodiment of the present invention can reproduce the audio signal from the sub-band signals at a relatively high quality, and keep memory utilization and the number of calculations as low as possible without deteriorating its sound quality by reason that each of the decoders provided in one-to-one relationship with sub-bands is adapted to preliminarily select quasi-optimal vectors from two or more code books, to produce an excitation vector from the preliminarily selected vectors on the basis of an analysis-by-synthesis method.

In the transmitter, the receiver, the wireless microphone system according to the second embodiment of the present invention, the compression encoder 4 of the receiver includes an audio signal dividing filter bank 4a for dividing an audio signal into four sub-band signals, and sampling each of the sub-band signals at a down-sampling rate depending on the number of the sub-band signals, the audio signal having 8 [MHz] or more wide frequency range. However, the present invention is not limited to what is shown in the drawings and described in the specification.

### Third Embodiment

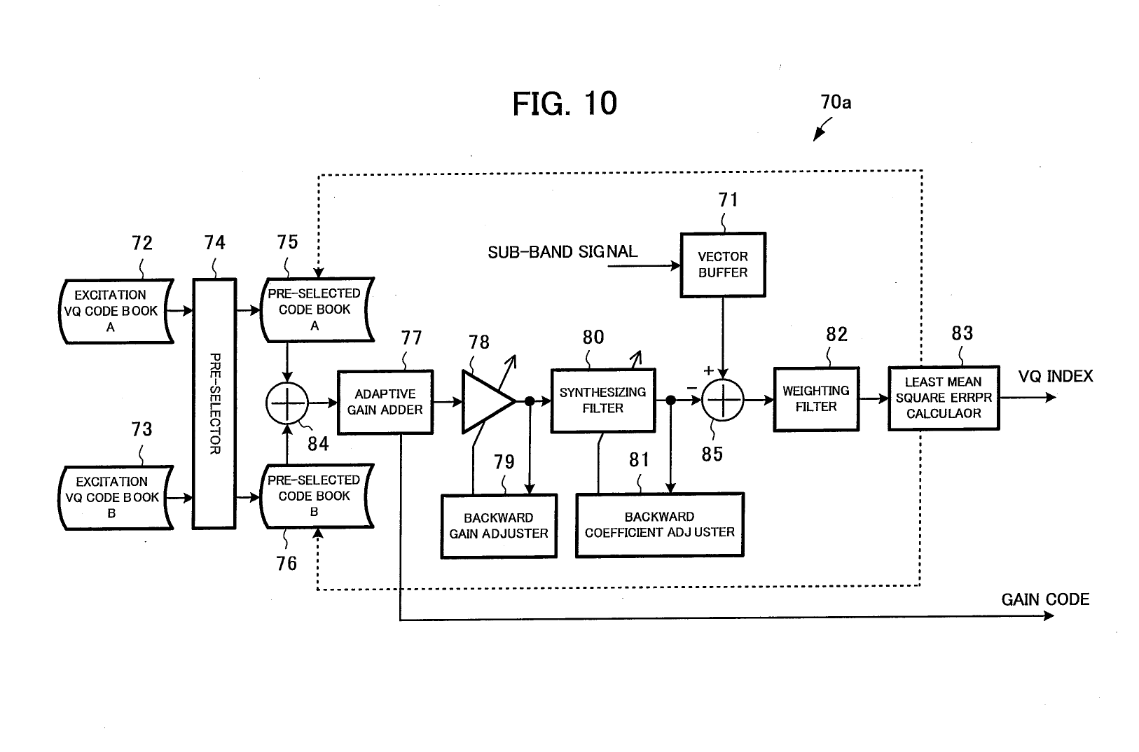

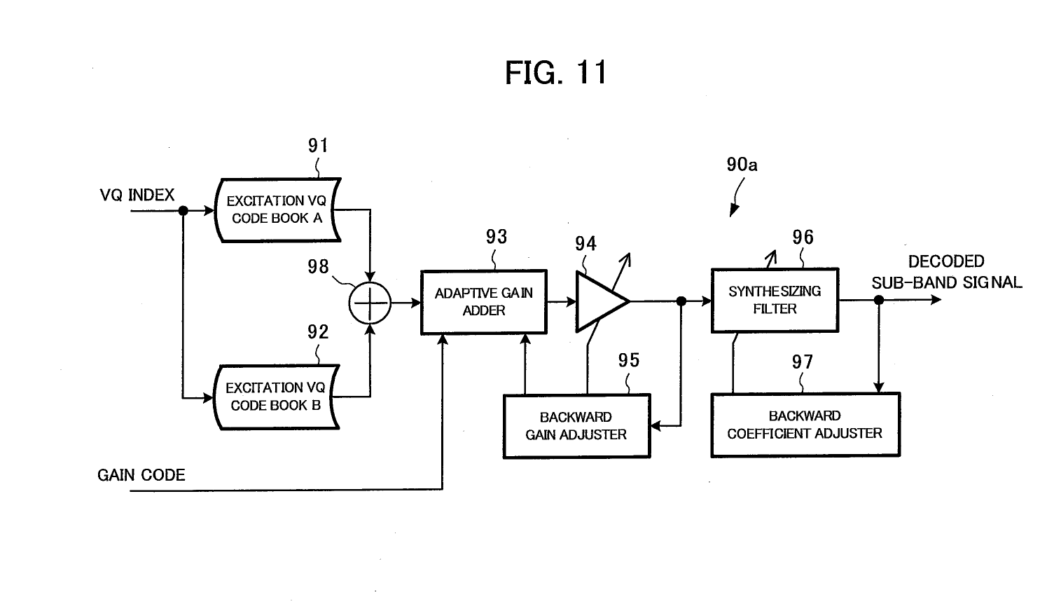

The transmitter, the receiver, and the wireless microphone system according to the third embodiment of the present invention with reference to FIGS. 10 and 11.

The wireless microphone system according to the third embodiment is similar in construction to the wireless microphone system according to the first embodiment. The wireless microphone system according to the third embodiment comprises a transmitter and a receiver.

The transmitter 101 of the wireless microphone system according to the third embodiment is similar in construction to the transmitter 101 of the wireless microphone system according to the first embodiment. The transmitter 101 of the wireless microphone system according to the third embodiment includes a microphone unit 1, an audio signal amplifier 2, an analog-to-digital converter 3, a compression encoder 4, an error correction encoder 5, a line encoder 6, a high frequency signal amplifier 7, a transmitting antenna 8.

The compression encoder 4 of the transmitter 101 includes an audio signal dividing filter bank 4a for dividing an audio signal into four sub-band signals, sampling each of the sub-band signals at a down-sampling rate depending on the number of the sub-band signals, the audio signal having 8 [MHz] or more wide frequency range, a vector encoder 4b for producing vector indexes from the sub-band signals on the basis of the Low delay—Code Exited Linear Prediction (hereinafter simply referred to as “LD-CELP”) algorithm by performing the vector quantization of the sub-band signals on the basis of an analysis-by-synthesis method, and a multiplexer 4c for producing a multiplexed data stream with the vector indexes produced and outputted by the vector encoder 4b. The vector encoder 4b includes four LD-CELP encoders 70a to 70d for performing the vector quantization of the respective sub-band signals.

As shown in FIG. 10, the LD-CELP encoders 70a to 70d includes a vector buffer 71, an excitation VQ code book A 72, an excitation VQ code book B 73, a pre-selector 74, a pre-selected code book A 75, a pre-selected code book B 76, an adaptive gain adder 77, a gain multiplier 78, a backward gain adjuster 79, a synthesizing filter 80, a backward coefficient adjuster 81, a weighting filter 82, and a least mean square error calculator 83.

On the other hand, the receiver 102 of the wireless microphone system according to the third embodiment is similar in construction to the receiver 102 of the wireless microphone system according to the first embodiment. The receiver 102 of the wireless microphone system according to the third embodiment includes a receiving antenna 9, a high frequency signal amplifier 10, an intermediate frequency signal amplifier 11, a demodulator 12, a line decoder 13, a code error corrector 14, a compressed signal decoder 15, a digital effecter 16, a digital-to-analog converter 17, an audio signal amplifier 18, and a speaker unit 19.

The receiver 102 includes a setting unit (not shown) for inputting parameters such as for example a receiving channel of the high frequency signal amplifier 10 and a bit rate of the compressed signal decoder 15, and a controlling unit (not shown) for controlling the elements of the receiver 102 on the basis of the parameters inputted by the setting unit (not shown).

On the other hand, the compressed signal decoder 15 of the receiver 102 includes a demultiplexer 15a for reproducing the vector indexes from the multiplexed data stream, a vector decoder 15b for reproducing the sub-band signals from the reproduced vector indexes, an audio signal synthesizing filter bank 15c for synthesizing the audio signal from the reproduced sub-band signals. The vector decoder 15b includes four LD-CELP decoders 90a to 90d for reproducing the respective sub-band signals from the vector indexes.

As shown in FIG. 11, each of the LD-CELP decoders 90a to 90d includes an excitation VQ code book A 91, an excitation VQ code book B 92, an adaptive gain adder 93, a gain multiplier 94, a backward gain adjuster 95, a synthesizing filter 96, and a backward coefficient adjuster 97.

The operation of the compression encoder 4 of the transmitter 101, and the operation of the compressed signal decoder 15 of the receiver 102 of the wireless microphone system thus constructed will be then described hereinafter with reference to FIGS. 10 and 11.

In the compression encoder 4 of the transmitter 101, the audio signal is firstly divided into four sub-band signals by the audio signal dividing filter bank 4a, the divided sub-band signals having respective frequency ranges. Each of the sub-band signals are then sampled at a skipping rate proportional to the dividing number of the frequency range. The down-sampled sub-band signals are then buffered in the vector buffer 71, the number of each of the down-sampled sub-band signals to be buffered in the vector buffer 71 is equal to the dimension of the vector space in which the quantization vector is defined. The pre-selector 74 is then operated to select two vectors from the excitation VQ code book A 72 and the excitation VQ code book B 73 as pre-selected excitation vectors approximately representing the inputted audio signal. The selected vectors are then stored in the pre-selected code book A 75 and the pre-selected code book B 76. It is preferable to preliminarily select vectors the on the basis of a quasi-optimal method which is lower in the number of calculations than an analysis-by-synthesis method, and in which the combination of the vectors is selected through the steps of processing each of a target vector (produced from the previously inputted audio signal) and an excitation VQ vector (indicative of the vectorial sum of the vectors obtained from the excitation VQ code book A 72 and the excitation VQ code book B 73) by the synthesizing filter 80 and the weighting filter 82, calculating the cross-correlation between the sum of the target vector and the excitation VQ vector, and maximizing the cross-correlation multiplied in the gain multiplier 78 by a backward gain. The vectorial sum of the vectors thus selected from the pre-selected code book A 75 and the pre-selected code book B 76 on the basis of the above-mentioned method is then calculated as a pre-selected exaction vector. An optimum gain is estimated in response to the pre-selected exaction vector, and multiplied by a gain that is calculated on the basis of the backward estimation. The optimum gain difference between the estimated optimum gain and the calculated gain is then calculated. The adaptive scalar quantization of the optimum gain difference is then performed by the adaptive gain adder 77. This quantization value is used on the basis of the analysis-by-synthesis method, while the gain multiplier 78 multiplies the excitation vector by the backward gain which is adaptively predicted by the backward gain adjuster 79. The sub-band audio signal is produced from the excitation vector multiplied by the backward gain by the synthesizing filter 80, while the filter coefficients of the synthesizing filter 80 is adaptively updated by the backward coefficient adjuster 81. The signal difference between the sub-band audio signal received from the synthesizing filter 80 and the sub-band signal received from the vector buffer 71 is then calculated by the adder 85, while the least mean square error of that signal difference is minimized by the least mean square error calculator 83 with VQ index which is outputted to the pre-selected code book A 75 and the pre-selected code book B 76, and which is finally outputted by the compression encoder 4 with gain code.

On the other hand, the compressed signal decoder 15 of the receiver 102 is firstly operated to receive the excitation VQ index from the transmitter 101, to select vectors from the excitation VQ code book A 91 and the excitation VQ code book B 92 on the basis of the received excitation VQ index. Here, the excitation VQ code book A 91 and the excitation VQ code book B 92 are the same as those of the encoder of the transmitter 101. The vectorial sum of the selected vectors is calculated as an excitation vector, while the vectorial sum of the selected vectors is adjusted in gain by the adaptive gain adder 93 and the gain multiplier 94 in a way the same as that of the compression encoder 4. The sub-band audio signal is then produced from the adjusted excitation vector. The prediction coefficients of the gain multiplier 94 and the synthesizing filter 96 are periodically updated by the backward gain adjuster 95 and the backward coefficient adjuster 97. The audio signal is synthesized from the sub-band audio signals by the audio signal synthesizing filter bank 15c.

From the foregoing description, it will be understood that the transmitter, the receiver, and the wireless microphone system according to the third embodiment of the present invention can encode the audio signal at a relatively high compression rate, reproduce the audio signal from the encoded audio signal at a relatively high quality, and keep memory utilization and the number of calculations as low as possible by reason that each of the decoders is adapted to preliminarily select quasi-optimal vectors from two or more code books, to produce an excitation vector from the pre-selected vectors the analysis-by-synthesis method, and to perform the adaptive scalar quantization of the gain in each excitation vector.

### INDUSTRIAL APPLICABILITY OF THE PRESENT INVENTION

As will be seen from the foregoing description, the audio signal encoding method, the audio signal decoding method, the transmitter, the receiver, and the wireless microphone system according to the present invention can encode the audio signal at a relatively high compression ratio with a relatively low delay, and transmit the encoded audio signal at a relatively low transmission rate. The present invention is available in communication system for performing wireless or wire communication through a relatively narrow transmission channel.

What is claimed is:

1. An audio signal encoding method, comprising:
a producing step of dividing an audio signal into a plurality of sub-band signals, sampling said sub-band signals at respective down-sampling rates depending on the number of said divided sub-band signals, and producing down-sampled sub-band signals; and
an encoding step of producing vector indexes from said down-sampled sub-band signals by performing the vector quantization of said down-sampled sub-band signals on the basis of an analysis-by-synthesis method, said encoding step being of calculating a linear predictive coefficient from a previously decoded signal on the basis of a backward adaptive prediction method.

2. The audio signal encoding method as set forth in claim 1, in which said encoding step is of producing an excitation vector by using the addition of at least two vector code books.

3. The audio signal encoding method as set forth in claim 1, in which said encoding step is of calculating, as a difference signal, the difference between a predictive excitation gain and a real excitation gain, and performing the adaptive scalar quantization of said difference signal.

4. In an audio signal decoding method of decoding an audio signal encoded on the basis of an audio signal encoding method which comprises a producing step of dividing said audio signal into a plurality of sub-band signals, sampling said sub-band signals at respective down-sampling rates depending on the number of said divided sub-band signals, and producing down-sampled sub-band signals; and an encoding step of producing vector indexes from said down-sampled sub-band signals by performing the vector quantization of said down-sampled sub-band signals on the basis of an analysis-by-synthesis method, said encoding step being of calculating a linear predictive coefficient from a previously decoded signal on the basis of a backward adaptive prediction method,
said audio signal decoding method comprises a decoding step of reproducing said down-sampled sub-band signals from said vector indexes by performing the inverse vector quantization of said vector indexes, and a synthesizing step of interpolating said reproduced sub-band signals at respective up-sampling rates, and reproducing said audio signal from said interpolated sub-band signals, said decoding step being of calculating a linear predictive coefficient from a previously decoded signal on the basis of said backward adaptive prediction method.

5. The audio signal decoding method as set forth in claim 4, in which said decoding step is of receiving said vector indexes encoded on the basis of said audio signal encoding method in which said encoding step is of producing an excitation vector by using the addition of at least two vector code books, and said decoding step is of producing an excitation vector by using the addition of at least two vectors equivalent to said vector indexes.

6. The audio signal decoding method as set forth in claim 4, in which said decoding step is of receiving said vector indexes encoded on the basis of said audio signal encoding method in which said encoding step is of calculating, as a difference signal, the gain difference between a predictive excitation gain and a real excitation gain, and performing the adaptive scalar quantization of said difference signal, and said decoding step is of calculating, as an excitation gain, the addition between said predictive excitation gain and said gain difference obtained from said quantized difference signal on the basis of said backward adaptive prediction method.

7. In a transmitter comprising an encoding unit for encoding an audio signal on the basis of an audio signal encoding method which comprises a producing step of dividing said audio signal into a plurality of sub-band signals, sampling said sub-band signals at respective down-sampling rates depending on the number of said divided sub-band signals, and producing said sub-band signals sampled at said down-sampling rates, and an encoding step of producing vector indexes from said down-sampled sub-band signals by performing the vector quantization of said down-sampled sub-band signals on the basis of an analysis-by-synthesis method, said encoding step being of calculating a linear predictive coefficient from a previously decoded signal on the basis of a backward adaptive prediction method,
said transmitter is adapted to transmit said audio signal encoded by said encoding unit, wherein
said encoding unit includes an audio signal dividing filter bank for dividing said audio signal into a plurality of sub-band signals, sampling said sub-band signals at respective down-sampling rates depending on the number of said divided sub-band signals, and producing said sub-band signals sampled at said down-sampling rates, and an encoder for producing vector indexes from said down-sampled sub-band signals by performing the vector quantization of said down-sampled sub-band signals on the basis of an analysis-by-synthesis method, said encoder being adapted to calculate a linear predictive coefficient from a previously decoded signal on the basis of a backward adaptive prediction method.

8. The transmitter as set forth in claim 7, in which
said encoder is adapted to produce an excitation vector by using the addition of at least two vector code books on the basis of said audio signal encoding method in which said encoding step is of producing an excitation vector by using the addition of at least two vector code books.

9. The transmitter as set forth in claim 7, in which
said encoder is adapted to produce a difference signal indicative of the difference between a predictive excitation gain and a real excitation gain, and performing the adaptive scalar quantization of said difference signal on the basis of said audio signal encoding method in which said encoding step is of calculating, as a difference signal, the difference between a predictive excitation gain and a real excitation gain, and performing the adaptive scalar quantization of said difference signal.

10. A receiver comprising a decoding unit for receiving an audio signal encoded on the basis an audio signal encoding method which comprises a producing step of dividing said audio signal into a plurality of sub-band signals, sampling said sub-band signals at respective down-sampling rates depending on the number of said divided sub-band signals, and producing said sub-band signals sampled at said down-sampling rates, and an encoding step of producing vector indexes from said down-sampled sub-band signals by performing the vector quantization of said down-sampled sub-band signals on the basis of an analysis-by-synthesis method, said encoding step being of calculating a linear predictive coefficient from a previously decoded signal on the basis of a backward adaptive prediction method, said decoding unit being adapted to decode said received audio signal on the an audio signal decoding method which comprises a decoding step of reproducing said sub-band signals from said vector indexes by performing the inverse vector quantization of said vector indexes, and a synthesizing step of interpolating said reproduced sub-band signals at respective up-sampling rates, and reproducing an audio signal from said interpolated sub-band signals, said decoding step being of calculating a linear predictive coefficient from a previously decoded signal on the basis of said backward adaptive prediction method, wherein
said decoding unit includes a decoder for reproducing said sub-band signals from said vector indexes by performing the inverse vector quantization of said vector indexes, and a sub-band synthesizing filter bank for interpolating said reproduced sub-band signals at respective up-sampling rates, and reproducing an audio signal from said interpolated sub-band signals, said decoder being adapted to calculate a linear predictive coefficient from a previously decoded signal on the basis of said backward adaptive prediction method.

11. The receiver as set forth in claim 7, in which
said decoder is adapted to produce an excitation vector by using the addition of at least two vector code books on the basis of said audio signal encoding method in which said encoding step of said audio signal encoding method is of producing an excitation vector by using the addition of at least two vector code books, and said decoding step is of producing an excitation vector by using the addition of at least two vectors equivalent to said vector indexes.

12. The receiver as set forth in claim 7, in which
said decoder is adapted to calculate, as an excitation gain, the addition between said predictive excitation gain and said gain difference obtained from said quantized difference signal on the basis of said audio signal decoding method in which said encoding step of said audio signal encoding method is of calculating, as a difference signal, the gain difference between a predictive excitation gain and a real excitation gain, and performing the adaptive scalar quantization of said difference signal, and said decoding step is of calculating, as an excitation gain, the addition between said predictive excitation gain and said gain difference obtained from said quantized difference signal on the basis of said backward adaptive prediction method.

13. A wireless microphone system, comprising:
a transmitter comprising an encoding unit for encoding an audio signal on the basis of an audio signal encoding method which comprises a producing step of dividing said audio signal into a plurality of sub-band signals, sampling said sub-band signals at respective down-sampling rates depending on the number of said divided sub-band signals, and producing said sub-band signals sampled at said down-sampling rates, and an encoding step of producing vector indexes from said down-sampled sub-band signals by performing the vector quantization of said down-sampled sub-band signals on the basis of an analysis-by-synthesis method, said encoding step being of calculating a linear predictive coefficient from a previously decoded signal on the basis of a backward adaptive prediction method, said transmitter being adapted to transmit said audio signal encoded by said encoding unit, wherein
said encoding unit includes an audio signal dividing filter bank for dividing said audio signal into a plurality of sub-band signals, sampling said sub-band signals at respective down-sampling rates depending on the number of said divided sub-band signals, and producing said sub-band signals sampled at said down-sampling rates, and an encoder for producing vector indexes from said down-sampled sub-band signals by performing the vector quantization of said down-sampled sub-band signals on the basis of an analysis-by-synthesis method, said encoder being adapted to calculate a linear predictive coefficient from a previously decoded signal on the basis of a backward adaptive prediction method.

14. A wireless microphone system as set forth in claim 13, which further comprises:
a receiver comprising a decoding unit for receiving an audio signal encoded on the basis an audio signal encoding method which comprises a producing step of dividing said audio signal into a plurality of sub-band signals, sampling said sub-band signals at respective down-sampling rates depending on the number of said divided sub-band signals, and producing said sub-band signals sampled at said down-sampling rates, and an encoding step of producing vector indexes from said down-sampled sub-band signals by performing the vector quantization of said down-sampled sub-band signals on the basis of an analysis-by-synthesis method, said encoding step being of calculating a linear predictive coefficient from a previously decoded signal on the basis of a backward adaptive prediction method, said decoding unit being adapted to decode said received audio signal on the an audio signal decoding method which comprises a decoding step of reproducing said sub-band signals from said vector indexes by performing the inverse vector quantization of said vector indexes, and a synthesizing step of interpolating said reproduced sub-band signals at respective up-sampling rates, and reproducing an audio signal from said interpolated sub-band signals, said decoding step being of calculating a linear predictive coefficient from a previously decoded signal on the basis of said backward adaptive prediction method, wherein
said decoding unit includes a decoder for reproducing said sub-band signals from said vector indexes by performing the inverse vector quantization of said vector indexes, and a sub-band synthesizing filter bank for interpolating said reproduced sub-band signals at respective up-sampling rates, and reproducing an audio signal from said interpolated sub-band signals, said decoder being adapted to calculate a linear predictive coefficient from a previously decoded signal on the basis of said backward adaptive prediction method.
